(19) United States
(12) Patent Application Publication
(10) Pub. No.: US 2026/0099977 A1
(43) Pub. Date: Apr. 9, 2026

(54) DESIGNATED GUIDE IN A SHARED VIRTUAL REALITY

(71) Applicant: Target Brands, Inc., Minneapolis, MN (US)

(72) Inventors: Robert S. Stumm, Edina, MN (US); Kameron A. Healy, Champlin, MN (US); Joseph A. Kieffer, Coon Rapids, MN (US); James M. Kraling, Minneapolis, MN (US); Sae Young Yoon, North St. Paul, MN (US); Nathan M. Hildman, Minneapolis, MN (US); Paul D. Eckhardt, Crystal River, FL (US); Marc J. Jensen, Golden Valley, MN (US); Jonathon T. Dossman, Manitou Springs, CO (US); Zachary Q. Wendt, Shakopee, MN (US)

(21) Appl. No.: 19/339,937

(22) Filed: Sep. 25, 2025

Related U.S. Application Data
(60) Provisional application No. 63/704,178, filed on Oct. 7, 2024.

(51) Int. Cl. G06T 13/40; H04L 67/131

(52) U.S. Cl. CPC G06T 13/40; H04L 67/131

(57) ABSTRACT

A virtual reality system includes a network, a server coupled to the network and a plurality of head mounted displays (HMDs) configured to be worn by each of a plurality of users in a group and being coupled to the network and the server. Each HMD is configured to render first and second virtual reality locations and includes a sensor. Each user including a designated guide is represented by a user avatar and are free to move and are tracked within a physical boundary of a physical location using the sensor. Each user in the physical location corresponds to a position of their user avatar in the first and second virtual reality locations. The designated guide's HMD configured to render the second virtual reality location in a preview mode. Upon the group being in acceptable positions, the group is navigated to the second virtual reality location.

### CROSS-REFERENCE TO RELATED APPLICATION

The present application is based on and claims the benefit of U.S. provisional patent application Ser. No. 63/704,178, filed Oct. 7, 2024, the content of which is hereby incorporated by reference in its entirety.

### SUMMARY

A virtual reality system includes a network, a virtual reality server coupled to the network, and a plurality of head mounted displays configured to be worn by each of a plurality of users in a group and being coupled to the network and the virtual reality server. One of the users is a designated guide of the group. Each head mounted display is configured to render at least first and second virtual reality locations and virtual reality objects and includes at least one sensor. Each user is represented by a user avatar in the at least first and second virtual reality locations. Each user including the designated guide are free to move and are tracked within a physical boundary of a physical location using the at least one sensor and a position of each user in the physical location corresponds to a position of the user avatar in the first and second virtual reality locations. The head mounted display worn by the designated guide is configured to render the second virtual reality location in a preview mode while the remaining head mounted displays worn by the remaining users in the group are configured to render the first virtual reality location. The designated guide is allowed to audibly instruct each user how to move in the physical location to be in an acceptable position in the second virtual reality location. Upon the group being in acceptable positions in the second virtual reality location, the designated guide is configured to navigate the group to the second virtual reality location by instructing that the head mounted displays in the group switch to rendering the second virtual reality location.

A virtual reality system including a network, a virtual reality server coupled to the network, and a plurality of head mounted displays configured to be worn by each of a plurality of users in a group and being coupled to the network and the virtual reality server. One of the users is a designated guide of the group. Each head mounted display is configured to render at least first and second virtual reality locations and virtual reality objects and includes at least one sensor. Each user is represented by a user avatar in the at least first and second virtual reality locations. Each user including the designated guide are free to move and are tracked within a physical boundary of a physical location using the at least one sensor and a position of each user in the physical location corresponds to a position of the user avatar in the first and second virtual reality locations. The head mounted display worn by the designated guide is configured to render the second virtual reality location in a preview mode and a position of each user avatar to allow the designated guide to verify that each user in the group is in an acceptable position within the second virtual reality location before the designated guide navigates the group of users to the second virtual reality location. The user avatars of the users other than the user avatar of the designated guide are rendered in the second virtual reality location in the preview move as second user avatars that are different from the first user avatars rendered in the first virtual reality location.

A virtual reality system includes a network, a virtual reality server coupled to the network and including a voice streaming server configured to stream audio data and a plurality of head mounted displays each configured to be worn by each of a plurality of users in a group and being coupled to the network and the virtual reality server. Each head mounted display is configured to render at least first and second virtual reality locations and virtual reality objects and includes at least one microphone and at least one speaker. The voice streaming server is activated to stream audio data from the microphones associated with each head mounted display to the speakers associated with each head mounted display. One of the head mounted displays worn by one of the users is a designated guide of the group. Each user including the designated guide are free to move and are tracked within a physical boundary of a physical location using the at least one sensor and positions of each user in the physical location corresponds to a position of a corresponding user avatar rendered in the first and second virtual reality locations. The head mounted display worn by the designated guide is configured to render a preview of the second virtual reality location in a preview mode while the remaining of the head mounted displays in the group worn by the remaining users in the group are configured to render the first virtual reality location. The designated guide is allowed to audibly instruct through the at least one microphone and the stream of audio data to each user how to move in the physical location to be in an acceptable position in the second virtual reality location before the designated guide navigates the group to the second virtual reality location by instructing that the head mounted display in the group switch to rendering the second virtual reality location.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a virtual reality (VR) system according to an embodiment.

FIG. 2 illustrates a user wearing a head mounted display (HMD) and holding touch controllers according to an embodiment.

FIG. 3 illustrates a block diagram of an HMD according to an embodiment.

FIG. 4 illustrates a perspective view of a pair of touch controllers including a left-hand touch controller and a right-hand touch controller.

FIG. 5 illustrates a block diagram of one of the pair of touch controllers of FIG. 5.

FIG. 6 illustrates a block diagram of a VR server according to an embodiment.

FIG. 7 is a block diagram of a VR system according to another embodiment.

FIG. 8 illustrates a screenshot taken from an HMD display worn by a designated guide in a first VR location according to an embodiment.

FIG. 9 illustrates another screenshot taken from the HMD display worn by the designated guide in the first VR location according to an embodiment.

FIGS. 10A and 10B are screenshots taken from the HMD display worn by the designated guide's HMD in the first VR location including menus shown to the designated guide for selecting a second VR location and for selecting to preview the second VR location according to embodiments.

FIG. 11 illustrates a simplified screenshot taken from the HMD display worn by the designated guide in a preview mode in the second VR location according to an embodiment.

FIG. 12 illustrates another simplified screenshot taken from the HMD display worn by the designated guide in the second VR location according to an embodiment.

### DESCRIPTION

Virtual reality (VR) is a technology for creating three-dimensional virtual environments with specific functionality. Head mounted display (HMDs) or headsets may be used in combination with hand or touch controllers to generate and render realistic images, sounds and sensations that simulate a user's physical presence in a virtual environment. In particular, the user is able to look around an artificial world, move in it and may interact with virtual features or items in a meaningful way. Each HMD includes a display and lenses, a processor, memory both as RAM and storage, battery, head strap, integral speakers and microphones. The hand controllers include batteries, buttons, triggers and haptics.

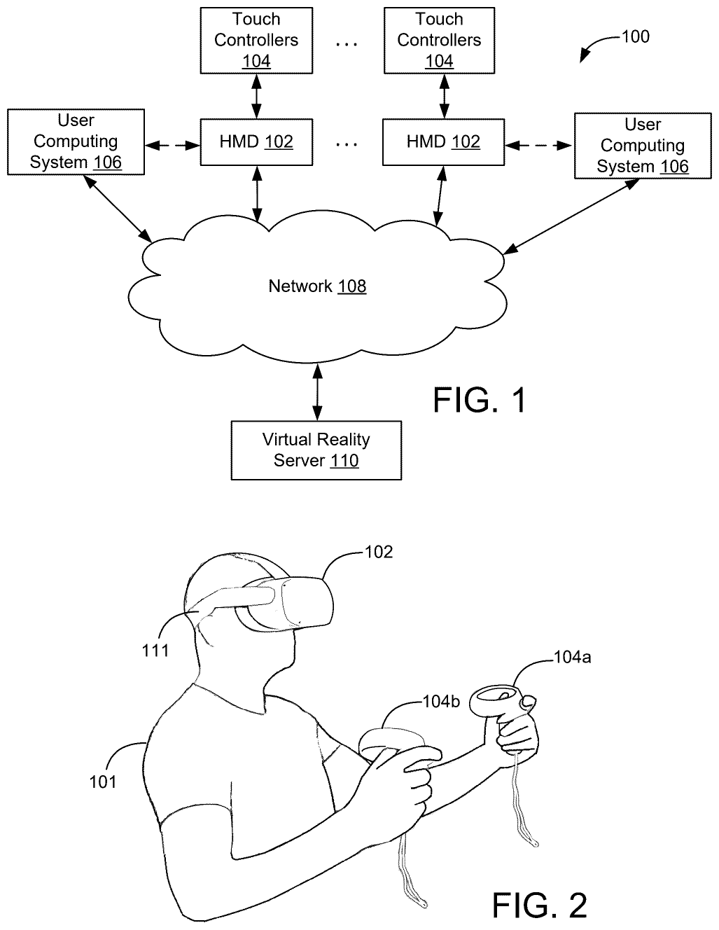

FIG. 1 is a block diagram of a virtual reality (VR) system 100 according to an embodiment. VR system 100 provides a simulated experience for users to view and/or collaboratively and individually design aspects of retail stores. VR system 100 may include a plurality of HMDs 102 each having a corresponding pair of handheld controllers or touch controllers 104 that communicate with their corresponding HMD 102. Together each HMD 102 and pair of touch controllers 104 are configured to generate and render realistic images, sounds and sensations that simulate a user's physical presence in a virtual reality environment.

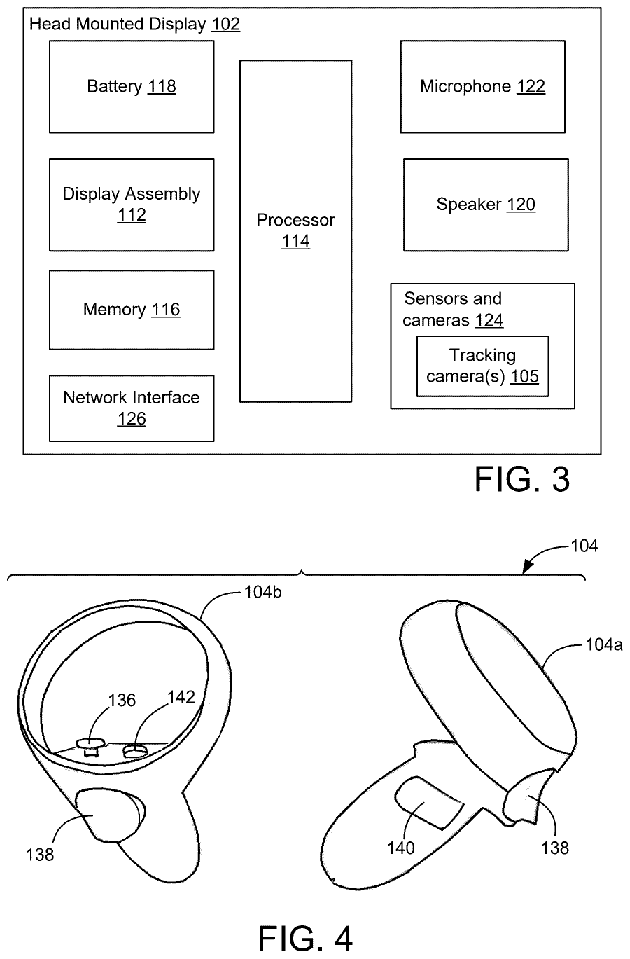

VR system 100 includes collaborative VR spaces or locations with synchronized media control and user avatars. As illustrated in FIG. 2, before entering the virtual reality, a user 101 may wear a headset 102 that is supported by the user's head and the user may grasp or hold touch controllers 104 in each hand. FIG. 2 illustrates a user 101 wearing HMD 102, which has a head strap 111, and holding left-hand touch controller 104a and right-hand touch controller 104b according to an embodiment. User 101, while wearing HMD 102 and holding touch controllers 104a and 104b, is able to look around an artificial world, move in it, and interact with virtual reality features or objects in a meaningful way. FIG. 3 illustrates a block diagram of HMD 102. HMD 102 includes a display or display assembly 112 having lenses configured to render virtual reality images of spaces and objects, a processor 114, memory (both as RAM and storage) 116, a battery 118, integral speakers 120, microphone(s) 122, one or more sensors 124 and a network interface 126 configured to interface with network 108. It should be realized that speakers 120, microphone(s) 122 and one or more sensors 124 may or may not be included in HMD 102 and may be separate from headset 102, but each speaker, microphone and sensor is associated with one of the HMDs 102 and the user to which the associated HMD 102 is worn. In addition, HMD 102 includes one or more tracking cameras 105. Tracking cameras 105 are operable to track both HMD 102 and the corresponding pair of touch controllers 104. It should be realized that it is also possible for tracking cameras 105 to perform hand tracking of a user's physical hands without the need for handheld touch controllers 104.

One or more sensors 124 are input devices that sense properties including acceleration and include one or more tracking cameras 105. Regardless of whether sensors and cameras 124 are mounted on HMD 102 (as illustrated) or are separate from HMD 102, sensors and cameras 124 including one or more tracking cameras 105 associated with each HMD 102 and are configured to sense positional tracking, touch controller tracking or hand tracking and may provide pass through viewing, which allows user 101 to temporarily view outside of the virtual reality provided by display 112 and see a real-time view of the environment around user 101.

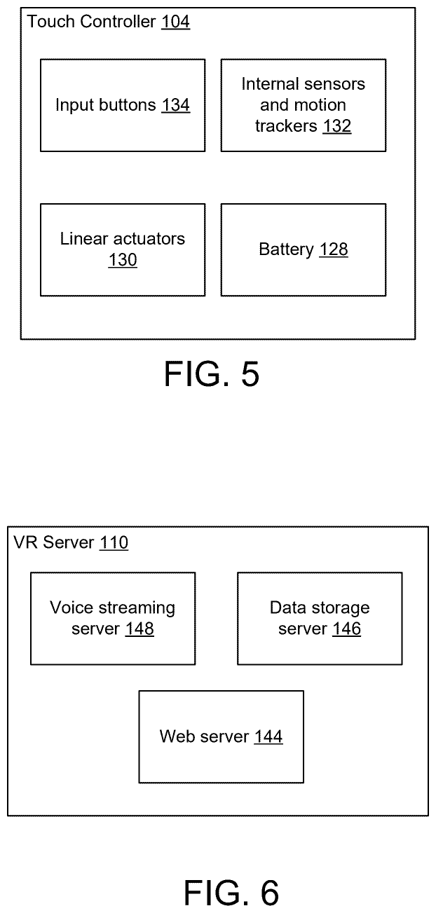

FIG. 4 illustrates a perspective view of pair of touch controllers 104 including left-hand touch controller 104a and right-hand touch controller 104b. FIG. 5 illustrates a block diagram of one of the pair of touch controllers 104. As illustrated in FIGS. 4 and 5, each touch controller 104a and 104b includes an internal battery 128, one or more linear actuators 130 to perform haptic feedback, internal sensors and motion trackers 132 including, for example, infrared LEDs that the one or more tracking cameras 105 on headset 102 uses to track touch controllers 104 and input buttons 134 including a thumb stick 136, trigger button 138, grip button 140 and face buttons 142.

Exemplary HMD 102 and corresponding touch controllers 104 may include the Meta Quest VR headsets and touch controllers, a brand owned by Meta Platforms, LLC. In addition, each headset 102 of VR system 100 may be capable of running as both a standalone headset with an internal operating system and/or connected with software running on a user computing system 106 over, for example, a USB connection. HMDs 102 and optional user computing system 106 are in communication with a network 108, for example, the Internet, in order to communicate with a virtual reality (VR) server 110. In addition, user computing system 106 may not be connected to a VR headset and corresponding touch controllers. In such an embodiment, user computing system 106 includes controls (such as hand controls or a keyboard) for controlling movement in VR system 100, a display for displaying the virtual world, but without a headset, and a microphone and speaker for providing voice communication.

FIG. 6 illustrates a block diagram of VR server 110 according to an embodiment. VR server 110 is configured to deliver content and presentation logic, collect and distribute user events, implement logic and store data. Embedded with VR server 110 is a web server 144, a data storage server 146, and a voice streaming server 148. Web server 144 is configured to allow VR server 110 to communicate with a web client. However, web clients are not the only kind of possible client and other types of communication servers may be used. Data storage server 146 is configured to store data including transient data for data privacy and protection. Voice streaming server 148 is included so that users wearing headsets 102 may communicate via voice with other users in VR system 100 who are wearing HMDs 102. In particular, voice streaming server 148 is configured to stream audio data.

Upon entering the virtual reality, by donning HMD 102 and holding touch controllers 104a and 104b in each hand, a distance between the physical real-world floor and the touch controllers 104a and 104b are determined by VR system 100. This determination allows user 101 to enter into the virtual reality of collaborative VR spaces with their user avatar being at their dimensionally correct height with respect to the artificial world. A user avatar is a graphical representation of a user in the virtual reality.

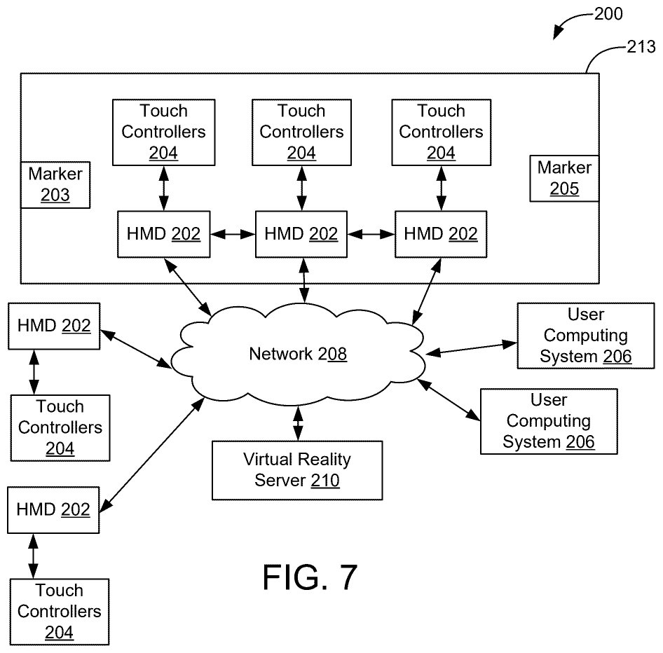

FIG. 7 is a block diagram of a virtual reality (VR) system 200 according to another embodiment. VR system 200 may include a plurality of HMDs 202, each configured to be worn by each of a plurality of users in a group of users and coupled to a network 208 and a virtual reality server 210. Each HMD 202 has a corresponding pair of handheld controllers or touch controllers 204 that communicate with their corresponding HMD 202. Together each HMD 202 and pair of touch controllers 204 and each user computing system 206 are configured to generate and render virtual reality (VR) locations including at least first and a second VR locations including rendering realistic VR objects, images, sounds and sensations that simulate a user's physical presence in a virtual reality environment. In addition, VR system 200 may include a plurality of user computing systems 206 that may not be connected to an HMD and corresponding touch controllers. In such an embodiment, user computing system 206 includes controls (such as hand controls or a keyboard) for controlling movement in VR system 100, a display for displaying the virtual world, but without a headset, and a microphone and speaker for providing voice communication.

VR system 200 provides a co-located shared VR simulated experience. In other words, users may share the same physical and virtual space simultaneously where VR users navigate the shared physical space and virtual environment together and are aware of the positions of the other users within the virtual environment and corresponding positions of the other users in the physical space. For example, in the physical space, some of the VR users may share a defined walkable area 213 and are aware of the positions of other users within the walkable area. In other embodiments, VR users in VR system 200 may be remotely located and do not share walkable area 213. In FIG. 7, co-located VR users include users of HMDs 202 and touch controllers 204 that are shown within walkable area 213. Remotely located VR users include users of HMDs 202 and touch controller 204 and user computing systems 206 that are shown outside of walkable area 213. In a co-located shared VR experience, a method is needed to calibrate HMDs or headsets used within the shared physical space to create a shared VR space. One exemplary calibration, as illustrated in FIG. 7, is a marker-based calibration where one or more markers 203 and 205 are placed in the physical space and are tracked simultaneously by sensors and/or cameras, for example sensors and cameras 124, and applications running on user's HMDs 202.

One application of a marker-based calibration includes using real-world reference points to create spatial anchor(s) to share real-world and real time X, Y and Z positioning data. For example, VR system 200 may include a first marker 203 and a second marker 205. This allows HMDs 202 located in walkable area 213 to understand their position relative to these real-world markers and allow them to “see” or sense the location of the other HMDs 202 in the real and virtual worlds. This tool requires a network connection to either a local or global network location to store the spatial anchor information so that it can be shared among users. Each HMD 202 in walkable area 213 has its own unique ID, which helps the devices recognize each other.

In a co-located shared Virtual Reality (VR) experience with users simultaneously sharing a physical and virtual space or location, and under one embodiment, one of the users may be a designated guide for users of the group in the co-located shared physical and virtual space. It should be realized that in other shared VR experiences where users may be remotely located from each other but share a virtual space or location, one of the users may still be a designated guide for all users.

Each HMD 102, 202 worn by each user including a designated guide are free to move and are tracked within walkable area or physical boundary 213 using at least one sensor 124. In other words, co-located users including the designated guide share a defined walkable area 213 in co-located shared VR system 200. Each user is represented by a user avatar in the virtual reality or first and second VR locations. A position of each user in the physical location corresponds with a position of a user avatar in the virtual reality or first and second VR locations. For remotely located users in the shared virtual reality, each remote user may navigate themselves to the shared virtual reality. Since each remote user is not located in the same physical location as co-located users, the position of their rendered user avatar within the virtual reality may not be tied to a physical location and they may or may not be under the control of the designated guide.

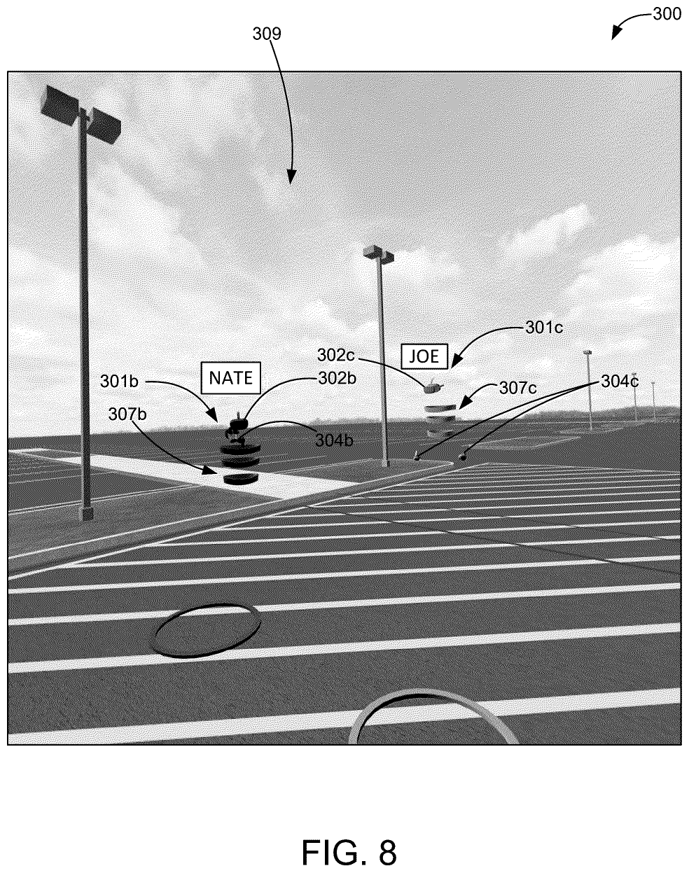

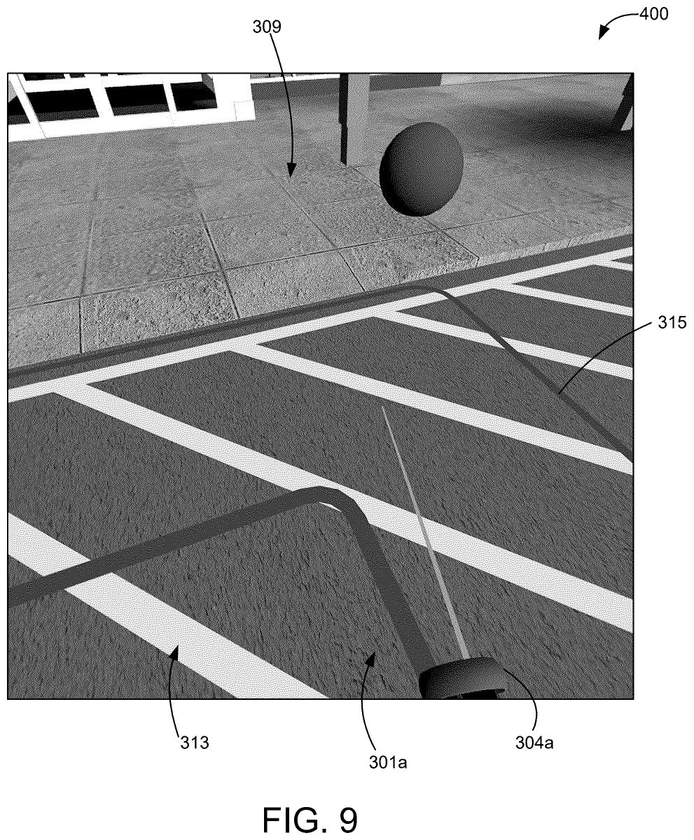

FIG. 8 illustrates a screenshot 300 taken from the HMD display worn by a designated guide 301a (FIG. 9) in a first VR location 309 according to an embodiment. Designated guide 301a is in the co-located shared VR experience or system with two other users: user Nate 301b and user Joe 301c. The users 301b and 301c including designated guide 301a are physically located together in walkable area 213 and visually represented in first VR location 309, each with first or primary user avatars. While only users in FIG. 8 are those users located in the walkable area 213 (FIG. 7), it should be realized that other users may be visually represented in first VR location 309. Each first or primary user avatar includes a set of graphical images including graphical images of headsets or HMDs 302b and 302c, graphical images of handheld devices or touch controllers 304b and 304c and graphical images of a plurality of continuous skeletal rings 307b and 307c. It should be realized that first or primary user avatars may be representative of other graphical images than the illustrated images, especially if the user is operating one of the remotely located user computing systems 206. Graphical images of HMDs 302b and 302c are positioned in virtual reality in a location that represents where respective heads of user bodies are located. Graphical images of handheld devices 304b and 304c are positioned in virtual reality in a location that represents where respective hands of user bodies are located. Graphical images of continuous skeletal rings 307b and 307c are positioned in virtual reality in a location that represents where respective torsos of user bodies are located. Because screenshot 300 is taken from a rendering of designated guide's 301a HMD display, the HMD, the handheld devices and the continuous skeletal rings of the first or primary user avatar representation of designated guide 301a are not illustrated.

FIG. 9 illustrates another screenshot 400 taken from the HMD display worn by the designated guide 301a in the first VR location 309 according to an embodiment. In FIG. 9, a graphical image of one of the handheld devices or touch controllers 304a of designated guide 301a is illustrated. Also illustrated is a graphical image of a virtual reality boundary 315 that defines a walkable area 313 in the first VR location 309. Walkable area 313 corresponds with walkable area 213 in the physical shared space. Walkable area 313 in first VR location 309 and therefore any other VR locations within the VR system 200 are walkable by all users of the VR system 200. This means designated guide 301a and other users in any VR location within VR system 200 including first VR location 309 are free to ambulate about the walkable area 313 defined by boundary 315 by way of, for example, physically walking. However other ways of moving within the boundary 315 are also possible, for example by teleporting. For example, a remotely located user may move about virtual reality boundary 315 by way of pointing and teleporting. While all users, whether or not they are sharing a physical space and are currently positioned in the virtual space and viewing first VR location 309 (FIGS. 8 and 9), the designated guide 301a may select a new location in the VR space, for example a second VR location that is different from first VR location 309 by way of, for example, a menu, in order to later navigate the entire group or a portion of the group of HMD users in first VR location 309 to the second VR location. In other words, designated guide 309 may be responsible for VR users in the group to switch from being positioned in and viewing first VR location 309 to being positioned in and viewing the second VR location.

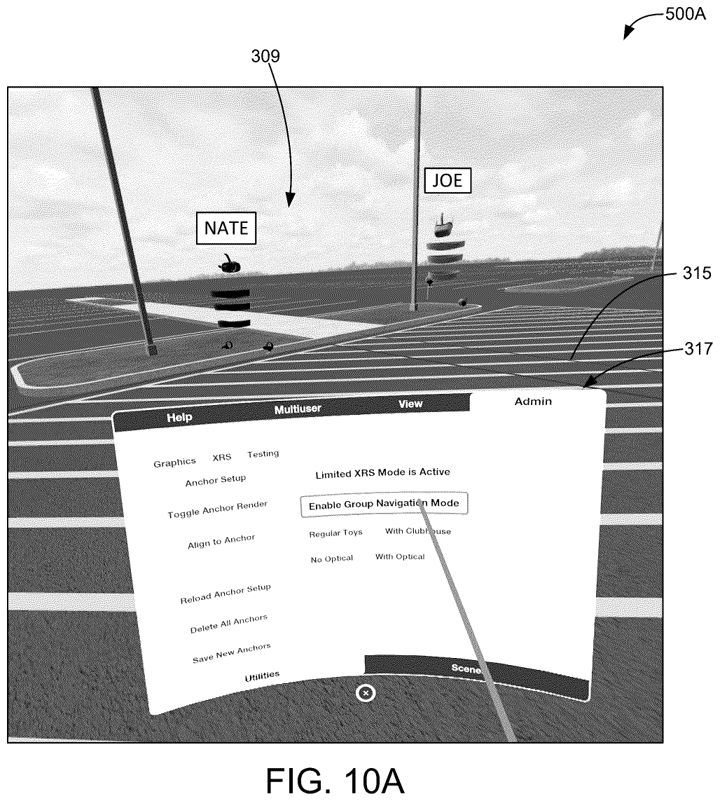

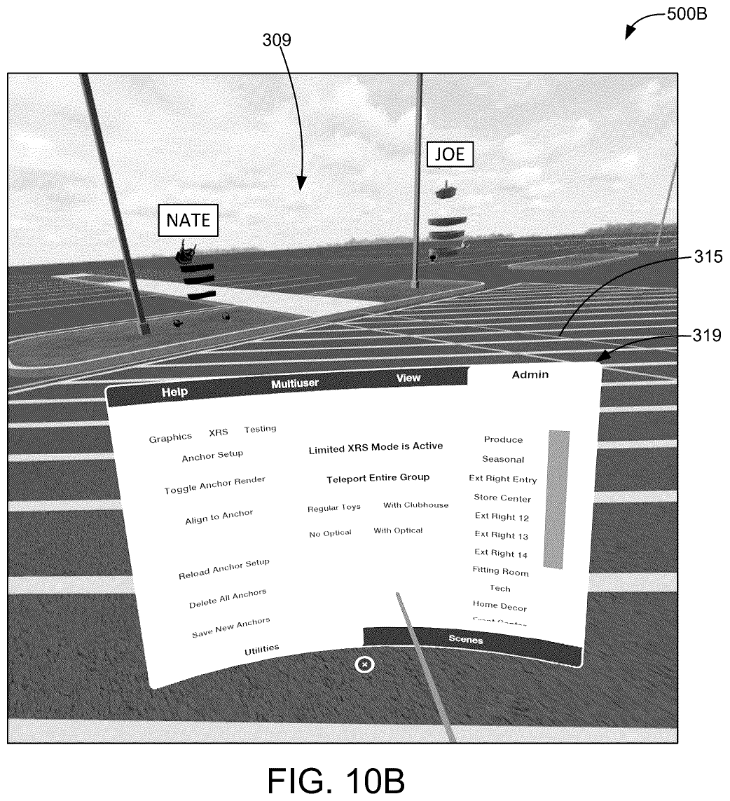

FIGS. 10A and 10B illustrate screenshots 500A and 500B, respectively, taken from the HMD display worn by the designated guide 301a including menus shown to the designated guide configured for selecting the new or second VR location and for selecting to preview the new or second VR location according to embodiments. As illustrated, menus and first VR location 309 are rendered on HMD 202 worn by designated guide 301a at the same time. FIG. 10A illustrates a first menu 317 where ‘Enable Group Navigation Mode’ may be selected to enable group navigation to a new, different or second VR location. FIG. 10B illustrates a second menu 319 where the new, different or second VR location may be selected. For example, the second VR location may be selected from a group of VR locations such as locations in a VR retail store including Produce, Seasonal, Exterior Right Entry, Store Center, Exterior Right 12, Exterior Right 13, Exterior Right 14, Fitting Room, Tech, Home Décor, etc.

Before designated guide 301a navigates the group of HMD users in first VR location 309 to the second VR location, designated guide 301a may select to preview the second VR location in a preview mode before all users in the group are navigated to the second VR location. HMD 202 worn by designated guide 301a is configured to render the second VR location in the preview mode while the remaining HMDs 202 worn by co-located or remaining users in the group and other users who are remotely located in the group are configured to continue to render the first VR location. It should be noted that designated guide 301a and all other users in the group maintain communications with each other, for example, by being able to hear each other in the same physical location and/or via microphones and speakers built into each HMD or user computing system and through voice streaming server 148, the preview of second VR location 609 in preview mode is limited to being available to designated guide 301a.

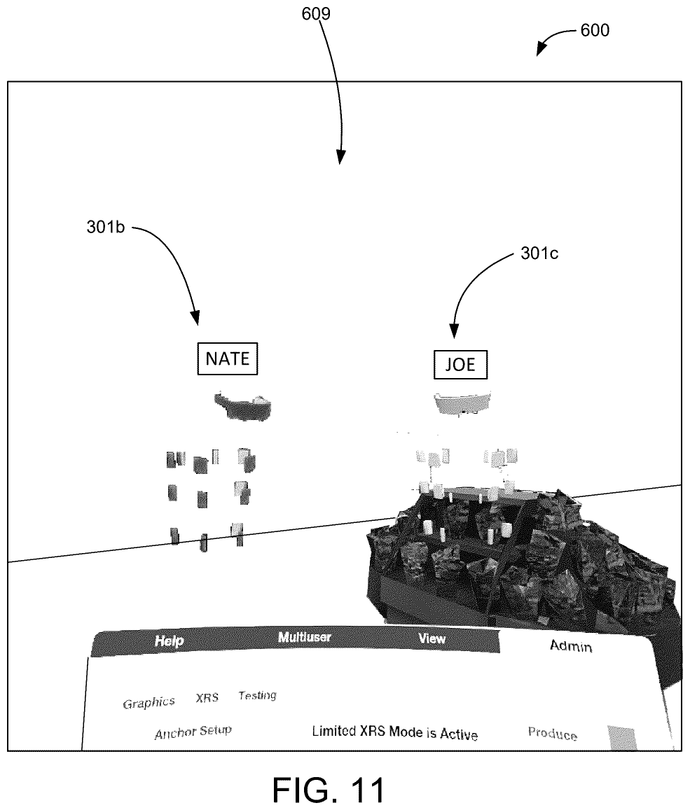

FIG. 11 illustrates a simplified screenshot 600 taken from the HMD display worn by the designated guide 301a in a preview mode of a second VR location 609 according to an embodiment. When in second VR location 609 in preview mode, the VR users 301b and 301c other than designated guide 301a are visually represented with second or preview user avatars that are different from their first or primary user avatars. While second or preview user avatars still include graphical images of a headset or HMDs 302b and 302c and graphical images of handheld devices or touch controllers 304b and 304c or other graphical images, the graphical images of the plurality of skeletal rings 307b and 307c are changed from being continuous to being discontinuous skeletal rings. In the rendering on the HMD display worn by designated guide 301a in preview mode, the plurality of discontinuous skeletal rings or second user avatars of users 301b and 301c are indicative of a user being a preview and not having yet navigated or moved to the second VR location whereas the plurality of continuous skeletal rings are indicative of a user being in a certain VR location in real-time. In addition, while designated guide 301a previews the second VR location, the user avatar of designated guide 301a in the first VR location is rendered as the second or preview user avatar. To the remaining users 301b and 301c viewing the first VR location, the plurality of discontinuous skeletal rings of the second user avatar of designated guide 301a are indicative of the designated guide 301a viewing a second VR location in a preview mode.

In preview mode, designated guide 301a is able to view where the remaining users 301b and 301c will land or be located in second VR location 609 before the remaining users 301b and 301c navigate to second VR location 609 while still being able to select from a menu and communicate with the other users 301b and 301c by virtue of being in the same physical location or over voice streaming server 148 using micorphones and speakers built into the HMDs or user computing systems. In particular, while in preview mode, the designated guide 301a assesses or verifies (by viewing each user's 301b and 301c second user avatars) whether any of the remaining users 301b and 301a will land or be located on top of or inside of a virtual object. Landing on or being located on top of or inside of a virtual object upon navigation may cause user discombobulation, which needs to be avoided. As illustrated in FIG. 11, if user 301b (Nate) remained in the same position in physical location 209 and therefore in first VR location 309, user 301b would be located on an open virtual floor in the second VR location 609, which would be an acceptable location. However, if user 301c (Joc) remained in the same position in physical location 209 and therefore in first VR location 309, user 301c would be located in a virtual object in the second VR location 609, which would be an unacceptable position.

Using the real-time communications while in preview mode, designated guide 301a is allowed to give audible instructions to the other users 301b and 301c how to move in the physical location 209 (i.e., the corresponding walkable area 213) or by way of teleportation to avoid landing in unacceptable locations in second VR location 609. Any movement in corresponding physical location 209 will translate to movement in first and second VR locations 309 and 609. After viewing FIG. 11, for example, designated guide 301a may ask users 301b and 301c each to move two steps to their right. Such audible instructions may be spoken into the microphone of the HMD 302a of designated guide 301a and may be received through the speakers of the HMDs 302b and 302c of each of users 301b and 301c. Upon hearing the audio instruction, VR users 301b and 301c move as instructed.

After users 301b and 301c have attained acceptable positions in second VR location 609, the designated guide 301a accepts or approves of the preview of second VR location 609. The designated guide 301a may briefly navigate and view the original VR location or first VR location 309 before the group of users navigate together in their first or primary user avatar to the new VR location or second VR location. In other words, designated guide 301a inputs to the system that all users 301a, 301b and 301c in the group are to switch from viewing first VR location 309 to viewing second VR location 609 at the same time. This action causes all user avatars of users 301a, 301b and 301c to change back to their first or primary user avatar.

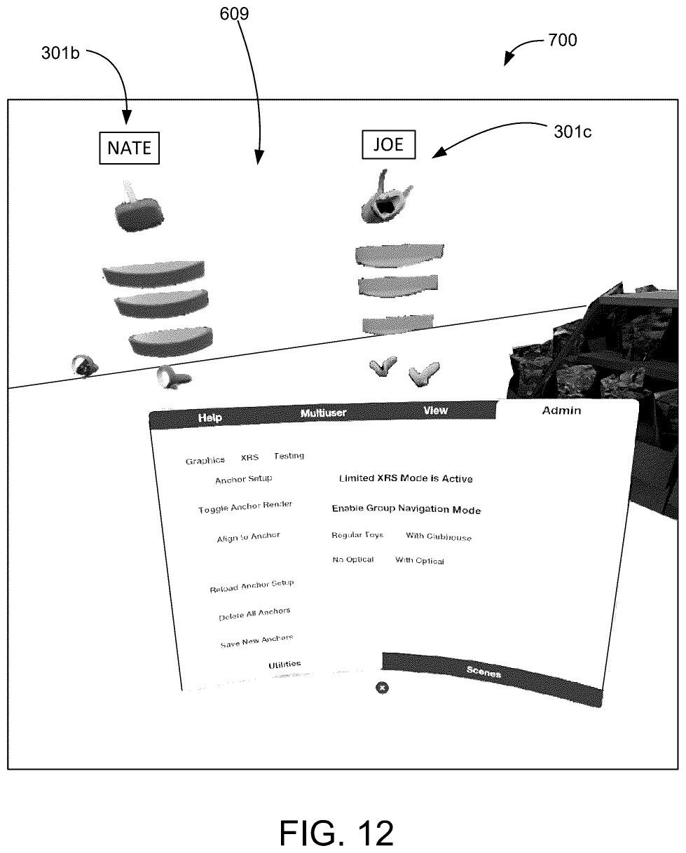

FIG. 12 illustrates another screenshot 700 taken from the HMD display of designated guide 301a in second VR location 609 after all users 301a, 301b and 301v have navigated according to an embodiment. As illustrated, VR users 301b and 301c have moved upon hearing audible instructions and are no longer in unacceptable locations and are in their first or primary user avatars.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A virtual reality system comprising:
a network;
a virtual reality server coupled to the network; and
a plurality of head mounted displays configured to be worn by each of a plurality of users in a group and being coupled to the network and the virtual reality server, wherein one of the users is a designated guide of the group;
wherein each head mounted display is configured to render at least first and second virtual reality locations and virtual reality objects and includes at least one sensor and wherein each user is represented by a user avatar in the at least first and second virtual reality locations;
wherein each user including the designated guide are free to move and are tracked within a physical boundary of a physical location using the at least one sensor and wherein a position of each user in the physical location corresponds to a position of their user avatar in the first and second virtual reality locations;
wherein the head mounted display worn by the designated guide is configured to render the second virtual reality location in a preview mode while the remaining head mounted displays worn by the remaining users in the group are configured to render the first virtual reality location, the designated guide being allowed to audibly instruct each user how to move in the physical location to be in an acceptable position in the second virtual reality location; and
wherein upon the group being in acceptable positions in the second virtual reality location, the designated guide is configured to navigate the group to the second virtual reality location by instructing that the head mounted displays in the group switch to rendering the second virtual reality location.

2. The virtual reality system of claim 1, wherein a selectable menu and the first virtual reality location are both rendered on the head mounted display of the designated guide at the same time, wherein upon selection by the designated guide, the preview of the second virtual reality location in the preview mode is rendered on the display of the head mounted display of the designated guide.

3. The virtual reality system of claim 1, wherein the user avatars are changeable between first user avatars and second user avatars, the first user avatars being graphically different from the second user avatars.

4. The virtual reality system of claim 3, wherein the first user avatars each comprise at least a plurality of continuous rings representative of a user torso.

5. The virtual reality system of claim 3, wherein the second user avatars each comprise at least a plurality of discontinuous rings representative of a user torso.

6. The virtual reality system of claim 3, wherein the user avatars that represent users other than the designated guide are rendered as the second user avatars in the second virtual reality location in the preview mode.

7. The virtual reality system of claim 3, wherein the user avatar that represents the designated guide is rendered as the second user avatar in the first virtual reality location in the preview mode.

8. The virtual reality system of claim 3, wherein after the designated guide navigates the group to the second virtual reality location, the user avatars including the user avatar of the designated guide are all rendered as the first user avatar.

9. The virtual reality system of claim 1, wherein the virtual reality server comprises a voice streaming server configured to stream audio data.

10. The virtual reality system of claim 9, wherein each of the head mounted displays worn by each virtual reality user including the designated guide comprises at least one microphone and at least one speaker, wherein the voice streaming server is activated to stream audio data from the at least one microphone associated with each head mounted display to the at least one speaker associated with each head mounted display, wherein the designated guide audibly instructs through the at least one microphone and the stream of audio data to each user how to move in the physical location to be in an acceptable position in the second virtual reality location.

11. A virtual reality system comprising
a network;
a virtual reality server coupled to the network; and
a plurality of head mounted displays configured to be worn by each of a plurality of users in a group and being coupled to the network and the virtual reality server, wherein one of the users is a designated guide of the group; and
wherein each head mounted display is configured to render at least first and second virtual reality locations and virtual reality objects and includes at least one sensor and wherein each user is represented by a user avatar in the at least first and second virtual reality locations;
wherein each user including the designated guide are free to move and are tracked within a physical boundary of a physical location using the at least one sensor and wherein a position of each user in the physical location corresponds to a position of their user avatar in the first and second virtual reality locations; and
wherein the head mounted display worn by the designated guide is configured to render the second virtual reality location in a preview mode and a position of each user avatar to allow the designated guide to verify that each user in the group is in an acceptable position within the second virtual reality location before the designated guide navigates the group of users to the second virtual reality location, wherein the user avatars of the users in the group other than the user avatar of the designated guide are rendered in the second virtual reality location in preview mode as second user avatars that are different from first user avatars rendered in the first virtual reality location.

12. The virtual reality system of claim 11, wherein the user avatar of the designated guide is rendered as the second user avatar in the first virtual reality location during the preview.

13. The virtual reality system of claim 11, wherein the first user avatars comprise graphical representations of at least a plurality of continuous rings that are representative of a user torso.

14. The virtual reality system of claim 13, wherein the second user avatars comprise graphical representations of at least a plurality of discontinuous rings that are representative of a user torso.

15. The virtual reality system of claim 11, further comprising at least one remotely located user coupled to the network and the virtual reality server, the at least one remotely located user is in at least the first virtual reality location.

16. The virtual reality system of claim 11, wherein the virtual reality server comprises a voice streaming server configured to stream audio data.

17. The virtual reality system of claim 16, wherein during the preview mode each of the head mounted displays worn by each user including the designated guide comprises at least one microphone and at least one speaker, wherein the voice streaming server is activated to stream audio data from the at least one microphone associated with each head mounted display to the at least one speaker associated with each head mounted display.

18. The virtual reality system of claim 17, wherein the head mounted display of the designated guide is configured to allow the designated guide to audibly instruct through the at least one microphone of its head mounted display and the stream of audio data to each user how to move in the physical location to be in an acceptable position in the second virtual reality location before the designated guide navigates the group of users to the second virtual reality location.

19. A virtual reality system comprising
a network;
a virtual reality server coupled to the network and including a voice streaming server configured to stream audio data;
a plurality of head mounted displays configured to be worn by each of a plurality of users in a group and being coupled to the network and the virtual reality server, each head mounted display is configured to render at least first and second virtual reality locations and virtual reality objects and includes at least one microphone and at least one speaker, wherein the voice streaming server is activated to stream audio data from the microphones associated with each head mounted display to the speakers associated with each head mounted display and wherein one of the head mounted displays worn by one of the users is a designated guide of the group; and
wherein each user including the designated guide are free to move and are tracked within a physical boundary of a physical location using the at least one sensor and wherein a position of each user in the physical location corresponds with a position of a corresponding user avatar in the first and second virtual reality locations; and
wherein the head mounted display worn by the designated guide is configured to render a preview of the second virtual reality location in a preview mode while the remaining of the head mounted displays worn by the remaining users in the group are configured to render the first virtual reality location, the designated guide is allowed to audibly instruct through the at least one microphone and the stream of audio data to each user how to move in the physical location to be in an acceptable position in the second virtual reality location before the designated guide navigates the group to the second virtual reality location by instructing that the head mounted displays in the group switch to rendering the second virtual reality location.

20. The virtual reality system of claim 19, wherein the user avatars other than the user avatar of the designated guide are rendered as second user avatars in the preview mode that are different from first user avatars rendered in the first virtual reality location.
